(19) United States
(12) Patent Application Publication
(10) Pub. No.: US 2004/0115606 A1
(43) Pub. Date: Jun. 17, 2004

(54) Training system

(76) Inventor: Brian Lawrence Davies, London (GB)

Correspondence Address: Roger H Stein, Wallenstein & Wagner, 53rd Floor, 311 South Wacker Drive, Chicago, IL, 60606-6630, US

(21) Appl. No.: 10/470,321

(22) PCT Filed: Jan. 29, 2002
(86) PCT No.: PCT/GB02/00366

(30) Foreign Application Priority Data
Jan. 29, 2001 (GB) 0102245.8

(51) Int. Cl. G09B 19/00; G09B 23/28

(52) U.S. Cl. 434/258; 434/262

(57) ABSTRACT

A training system for training a user in the operation of a tool comprises a two-axis actively-constrained computer-controlled motorised table (1000) which has a grip member (2000) attached to a pen (3000). In use, the system provides active constraint to a user, allowing the pen (3000) to move only within a narrow region of permitted motion. As the user becomes more proficient, the system gradually allows the user more freedom. In that way, the user becomes more proficient in performing certain physical motions. The system finds particular although not exclusive applicable in the training of surgeons, specifically in surgical implant procedures.

The present invention relates to a training system and method for assisting in training for physical motions. The invention is particularly although not exclusively applicable to train users in surgical applications, specifically surgical implant procedures. However, in its more general form, the invention relates to training not only in medicine, but across a range of industrial and social tasks requiring physical skills.

According to an aspect of the present invention there is provided a training system for training a user in the operation of a tool, comprising: a movable tool; a grip member coupled to the tool and gripped in use by a user to move the tool; a force sensor unit for sensing the direction and magnitude of the force applied to the grip member by the user; and a drive unit for constraining the movement of the tool in response to the sensed force in a definable virtual region of constraint.

Preferably, the training system further comprises: a control unit for controlling the drive unit such as to constrain the movement of the tool successively in increasingly-broader virtual regions of constraint.

Preferably, each region of constraint is a path.

In one embodiment the path is two-dimensional.

In another embodiment the path is three-dimensional.

Preferably, the grip member is a sprung-centred joystick.

According to another aspect of the present invention there is also provided a method of training a user in the operation of a tool, comprising the steps of: providing a training system including a movable tool, a grip member coupled to the tool and gripped by a user to move the tool, a force sensor unit for sensing the direction and magnitude of the force applied to the grip member by the user, and a drive unit for constraining the movement of the tool; and operating the drive unit to constrain the movement of the tool in response to the sensed force in a virtual region of constraint.

Preferably, the method further comprises the step of: operating the drive unit to constrain the movement of the tool in response to the sensed force in a further virtual region of constraint which is broader than the first region of constraint.

Preferably, each region of constraint is a path.

In one embodiment the path is two-dimensional.

In another embodiment the path is three-dimensional.

Preferably, the grip member is a fixed-mounted joystick.

The invention extends to a motor-driven mechanism, for example, an active-constraint robot, which includes back-driveable servo-controlled units and a grip member, for example, a lever or a ring, coupled through a force sensor unit. Within a virtual region of constraint defined by a computer control system, the mechanism would be easy to move, but at the limits of permitted movement, the user would feel that a resistive ‘wall’ had been met, preventing movement outside that region. By initially allowing the user to sweep out only a specific defined trajectory, the user's nervous system would be trained to make that motion. By gradually widening the region of constraint, the user would become gradually to rely on the inate control of body motion and less upon the constraining motion, and thus gradually develop a physical skill for that motion.

The invention may be carried into practice in a number of ways and several specific embodiments will now be described, by way of example, with reference to the accompanying drawings, in which:

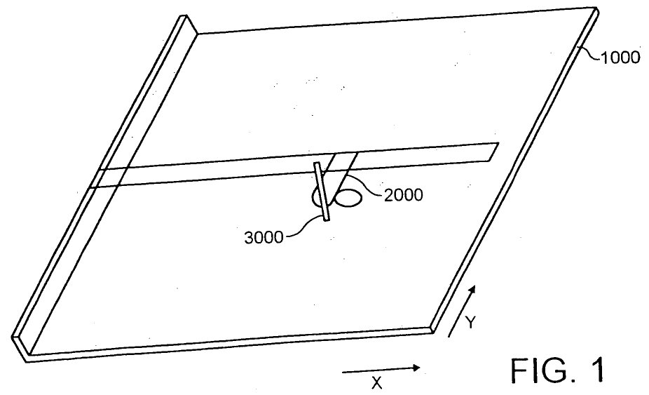

FIG. 1 illustrates a simple embodiment of a training system according to the present invention;

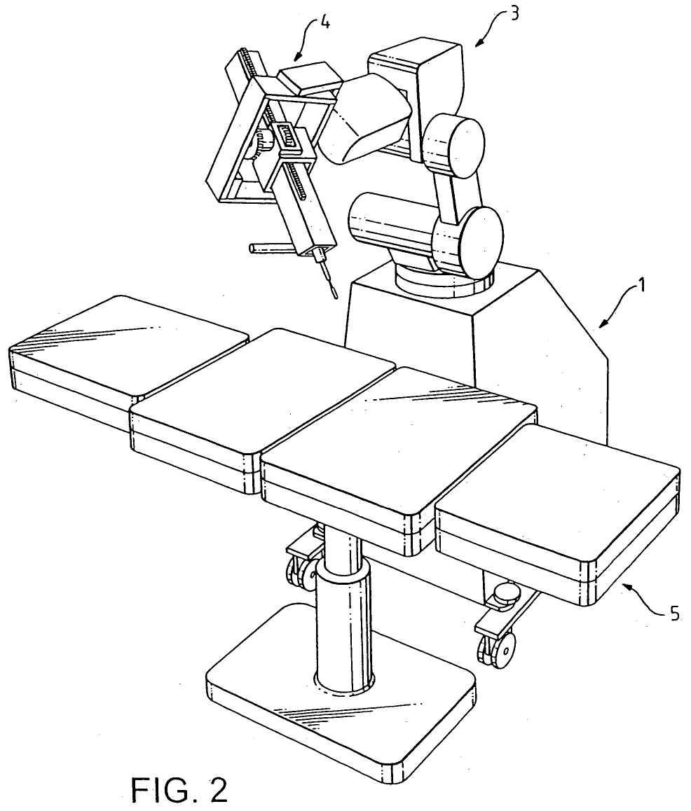

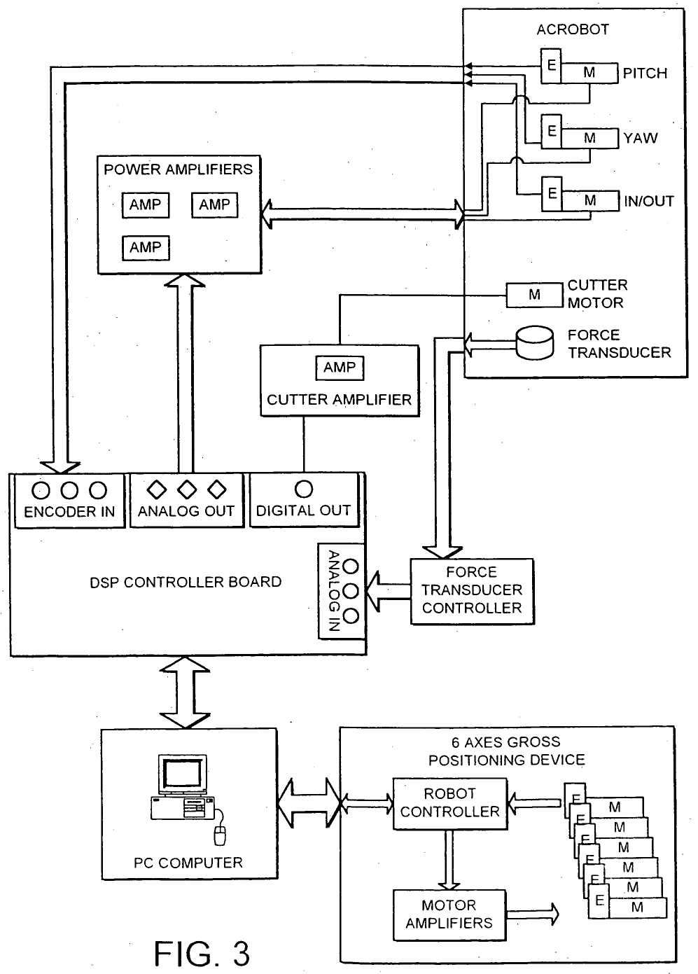

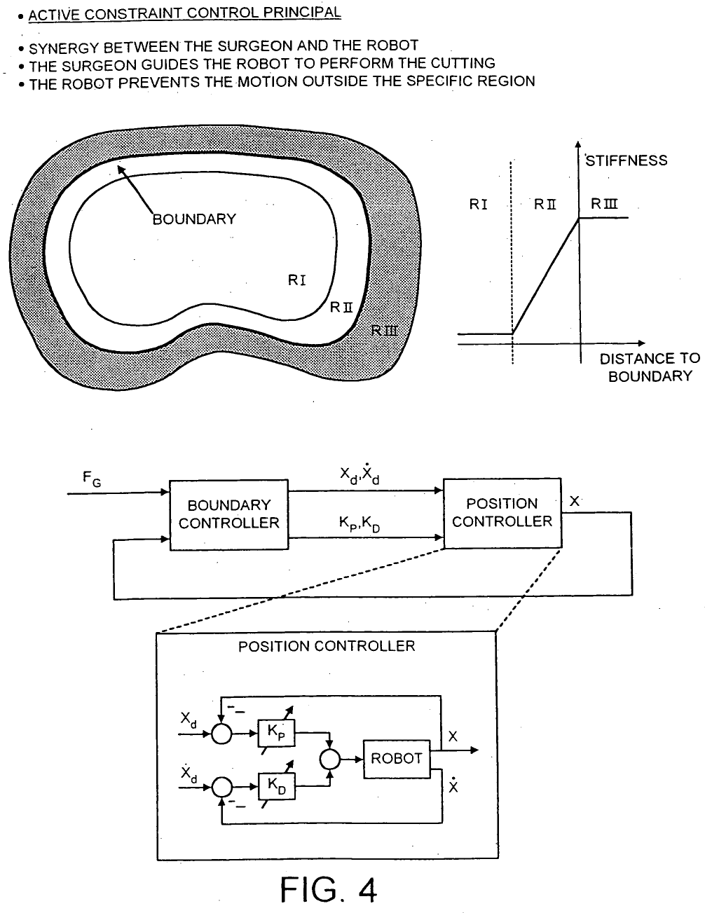

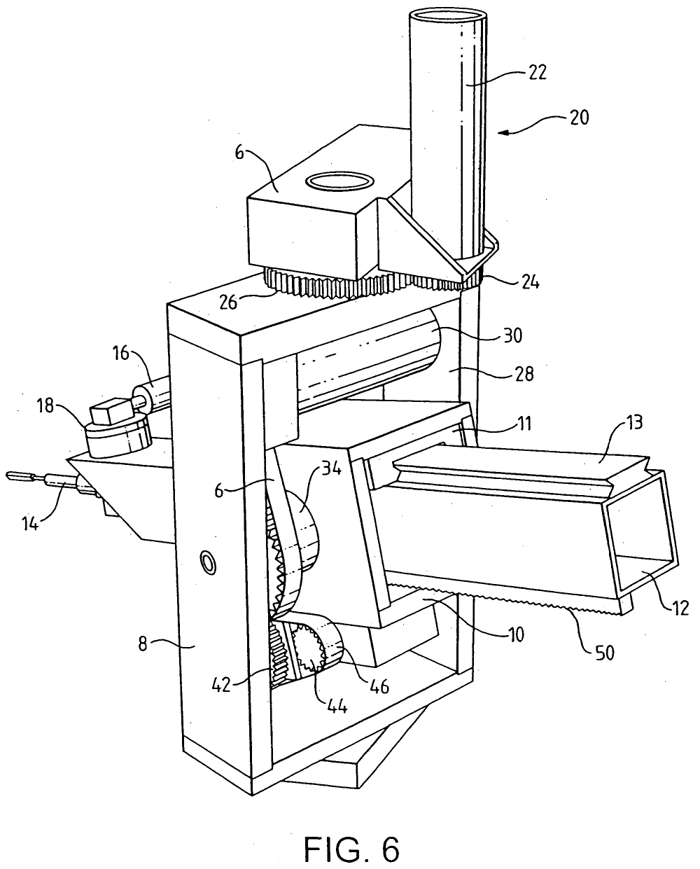

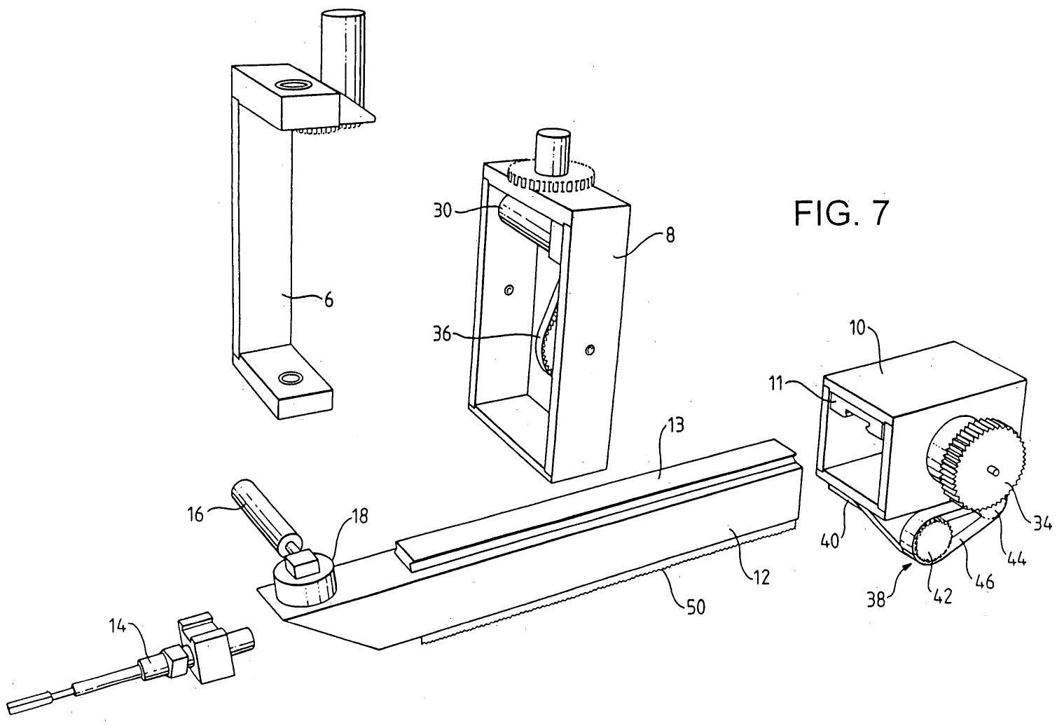

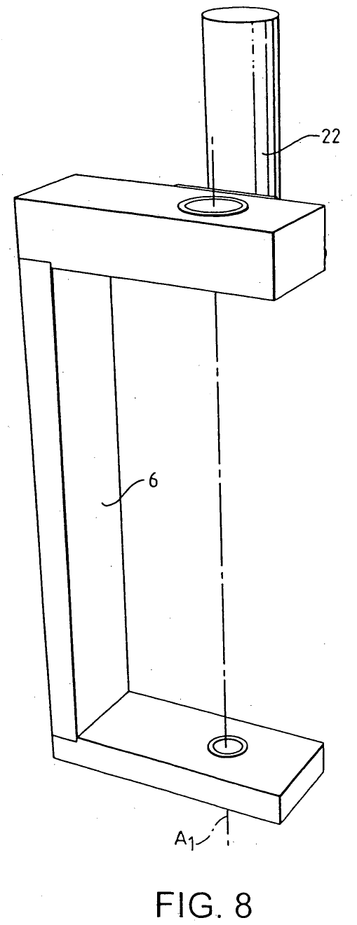

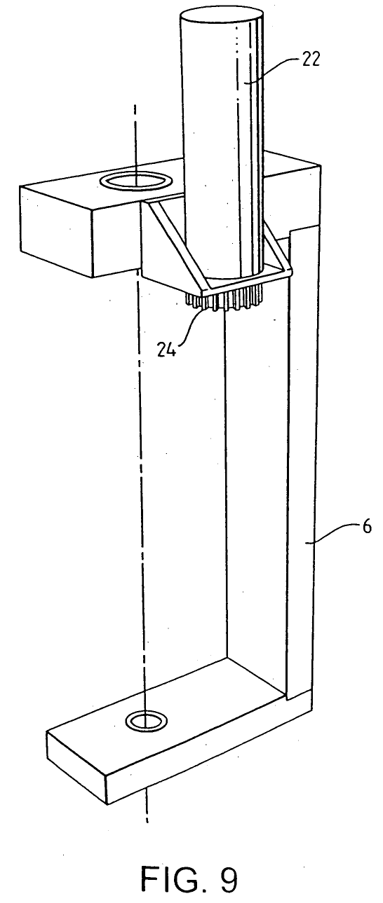

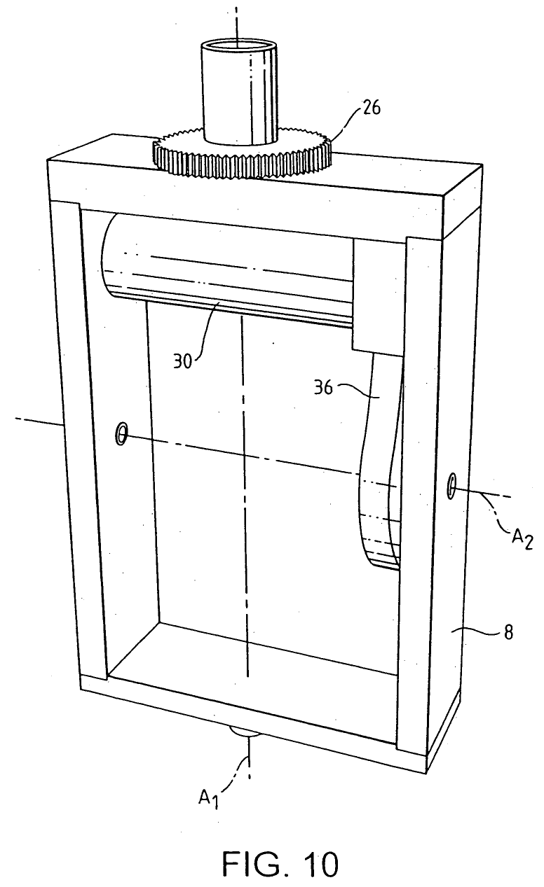

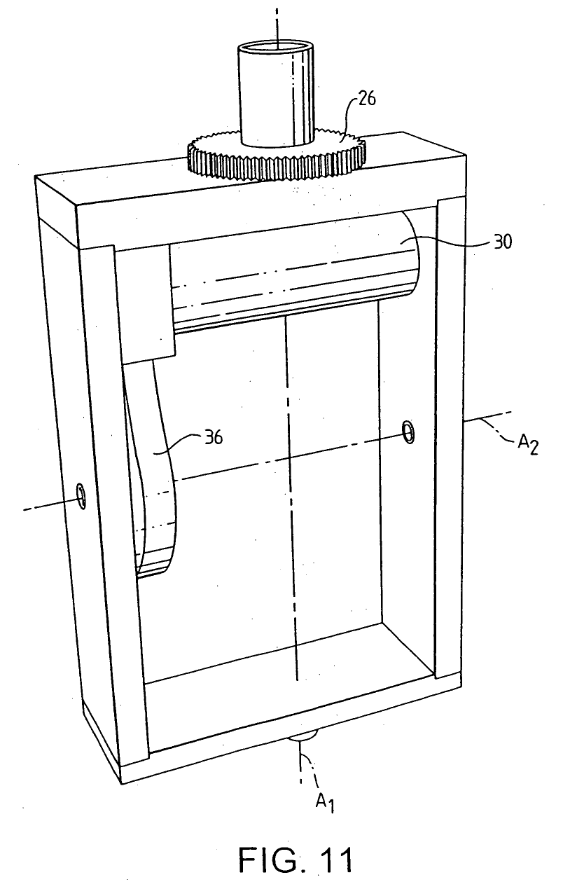

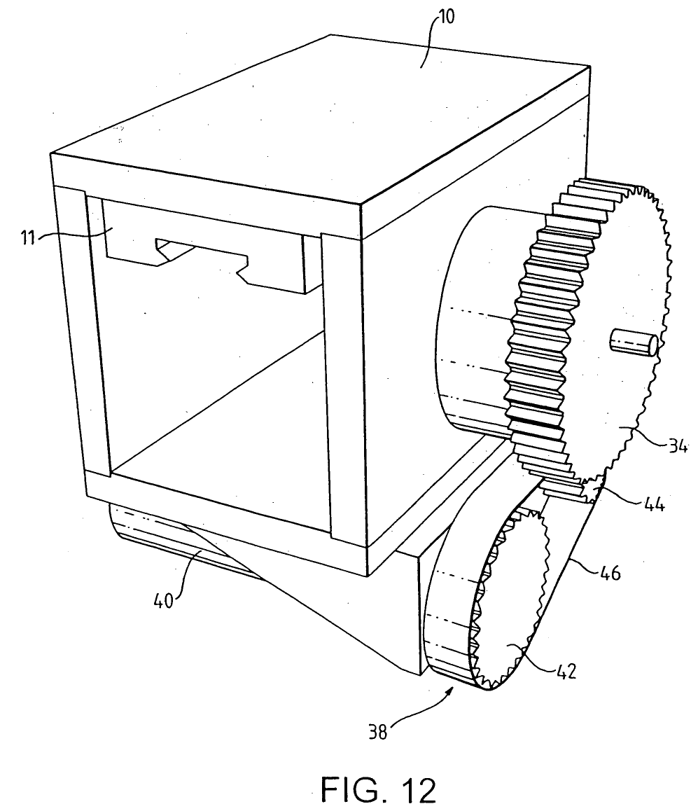

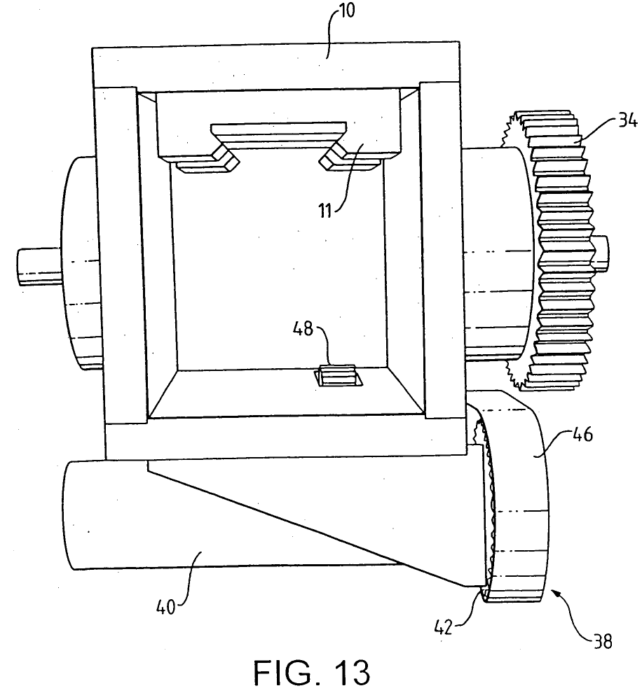

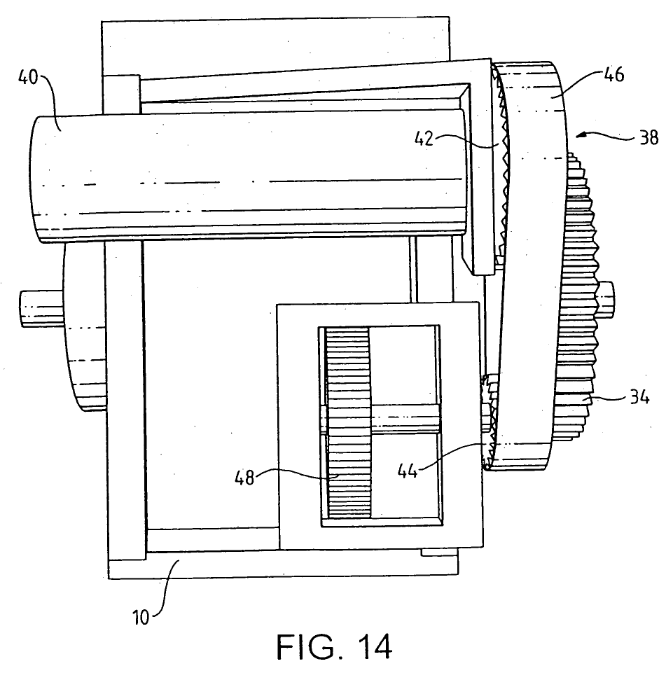

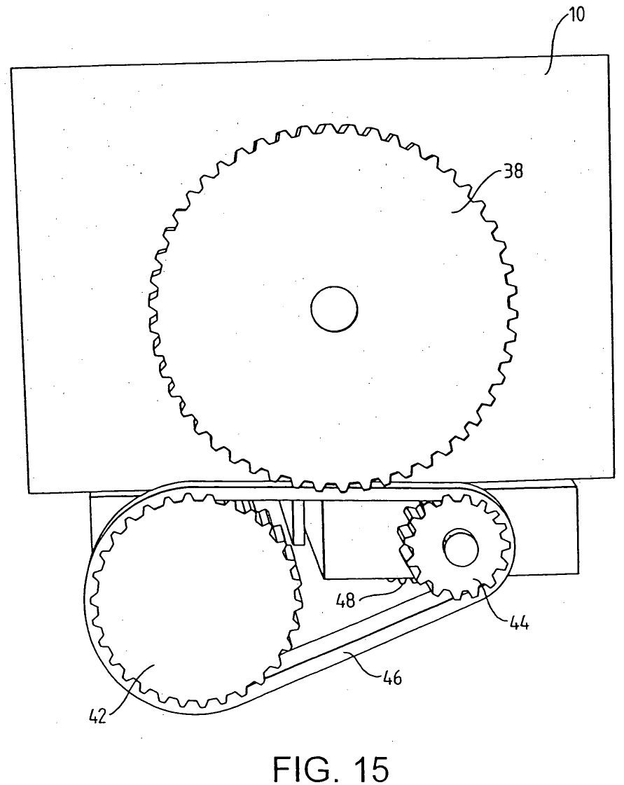

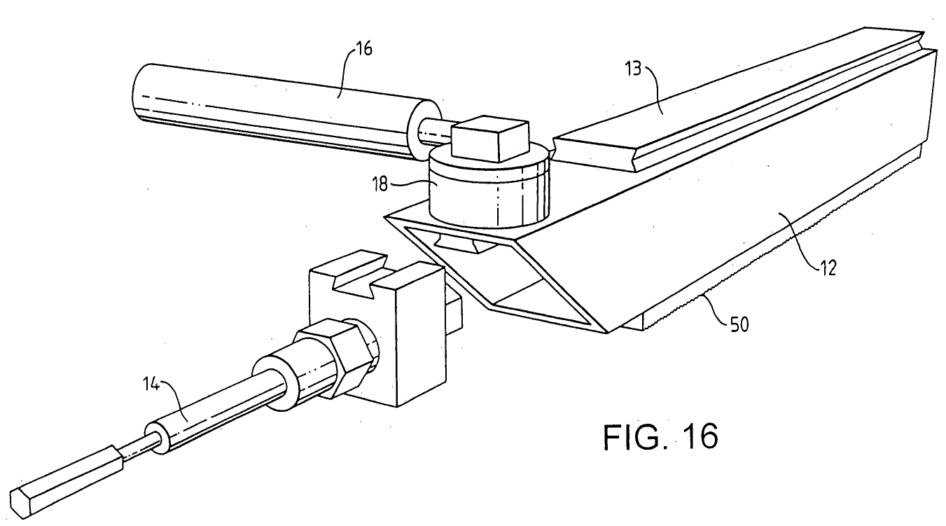

FIGS. 2 to 16 illustrate various facets of an ACROBOT™ robot system, according to a second embodiment of the invention;

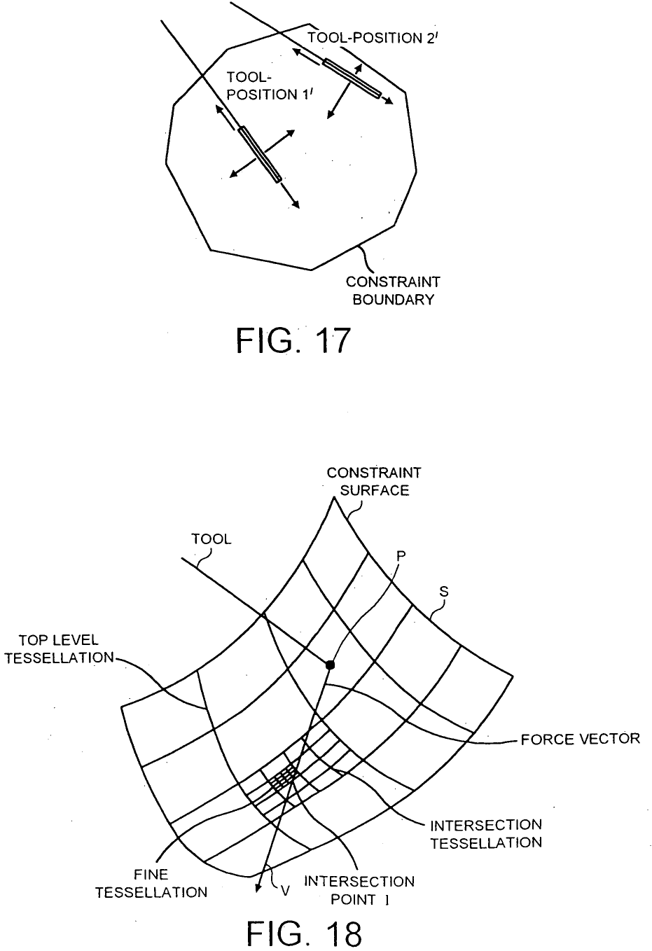

FIG. 17 illustrates the use of NURBS for a simple proximity test; and

FIG. 18 shows NURBS-based surface intersection.

FIG. 1 illustrates a simple embodiment of this aspect of the present invention. The system comprises a two-axis (x, y), actively-constrained computer-controlled motorised table 1000 which includes a grip member 2000, in this embodiment a ring, and to which is attached a pen 3000, much in the same manner as a plotter. The grip member 2000 is coupled by x and y force sensors to the body of the table 1000. In use, the grip member 2000 is grasped by a user to move the pen 3 over the table 1 and trace out pre-defined shapes and designs. Where, for example, a 45° line is to be drawn, the computer control system allows only movement of the pen 3000 along the 45° line. After the user's proprioceptive system had been trained in this motion over a period of time, the computer control system could be re-programmed to allow a wider region of permitted motion. This would allow the user some freedom, but still within a region of constraint bounded by two virtual surfaces on either side of the 45° line, and thereby provide some freedom to move either side of the 45° line. In this way, the constraint could be gradually widened and lessened as the user learned the motion and became adept at drawing the desired line.

In another embodiment, the region of constraint could be in 3D, with, for example, a z-motion of the pen 3000 being provided.

In yet another embodiment the pen 3000 could be replaced by, for example, an engraving tool, to permit 3D shapes to be cut, for example, on a copper plate.

As mentioned above, the computer control system could be configured to allow only a precise path and depth of prescribed motion initially, and then allow a groove of permitted motion and depth to be adjusted, to allow the user more freedom of motion as proprioceptive physical skill was developed.

The system could also embody a computer display for providing a visualisation of the actual tool location and path, as well as the desired path and pattern.

Further axes of motion could be supplied up to a full robotic system, for example having seven axes, with an appropriate number of force sensor inputs. A typical example of use would be in engraving a cut-glass vase, in which the cutter remained orthogonal to the vase surface. As the user were to move the force input over the vase surface, the control system would initially allow only the desired groove of the pattern to be followed. As physical skill was developed by the user, the groove could be gradually widened and the depth increased, to allow more freedom for the user to make mistakes and gradually be trained in the required movements, so that eventually the user could make the movements freehand, without the benefit of guidance.

The training system as previously described is preferably embodied by means of an ACROBOT™ active-constraint robot system, as described in more detail below with reference to FIGS. 2 to 16.

FIGS. 2 to 4 illustrate a surgical robot training system and the active-constraint principle thereof in accordance with a preferred embodiment of the present invention.

The surgical robot training system comprises a trolley 1, a gross positioner 3, in this embodiment a six-axis gross positioner, mounted to the trolley 1, an active-constraint robot 4 coupled to the gross positioner 3, and a control unit. The robot 4 is of smaller size than the gross positioner 3 and actively controllable by a surgeon within a virtual region of constraint under the control of the control unit.

The trolley 1 provides a means of moving the robot system relative to an operating table 5. The trolley 1 includes two sets of clamps, one for fixing the trolley 1 to the floor and the other for clamping to the operating table 5. In this way, the robot system and the operating table 5 are coupled as one rigid structure. Also, in the event of an emergency, the trolley 1 can be unclamped and easily removed from the operating table 5 to provide access to the patient by surgical staff.

The gross positioner 3 is configured to position the robot 4, which is mounted to the tip thereof, in an optimal position and orientation in the region where the cutting procedure is to be performed. In use, when the robot 4 is in position, the gross positioner 3 is locked off and the power disconnected. In this way, a high system safety is achieved, as the robot 4 is only powered as a sub-system during the cutting procedure. If the robot 4 has to be re-positioned during the surgical procedure, the gross positioner 3 is unlocked, re-positioned in the new position and locked off again. The structure of the control unit is designed such as to avoid unwanted movement of the gross positioner 3 during the power-on/power-off and locking/releasing processes.

The operating table 5 includes a leg fixture assembly for holding the femur and the tibia of the leg of a patient in a fixed position relative to the robot 4 during the registration and cutting procedures. The leg of the patient is immobilised in a flexed position after the knee is exposed. The leg fixture assembly comprises a base plate, an ankle boot, an ankle mounting plate, a knee clamp frame and two knee clamps, one for the tibia and the other for the femur. The base plate, which is covered with a sterile sheet, is clamped to the operating table 5 and acts as a rigid support onto which the hip of the patient is strapped. The ankle is located in the ankle boot and firmly strapped with Velcro™ fasteners. The ankle mounting plate, which is sterilised, is clamped through the sterile sheet onto the base plate. The ankle boot is then located in guides on the ankle mounting plate. In this way, both the hip and the ankle are immobilised, preventing movement of the proximal femur and the distal tibia. The knee clamp frame is mounted to the operating table 5 and provides a rigid structure around the knee. The knee clamps are placed directly onto the exposed parts of the distal femur and the proximal tibia. The knee clamps are then fixed onto the knee clamp frame, thus immobilising the knee.

The robot 4 is a special-purpose surgical training robot, designed specifically for surgical use. In contrast to industrial robots, where large workspace, high motion speed and power are highly desirable, these features are not needed in a surgical application. Indeed, such features are considered undesirable in introducing safety issues.

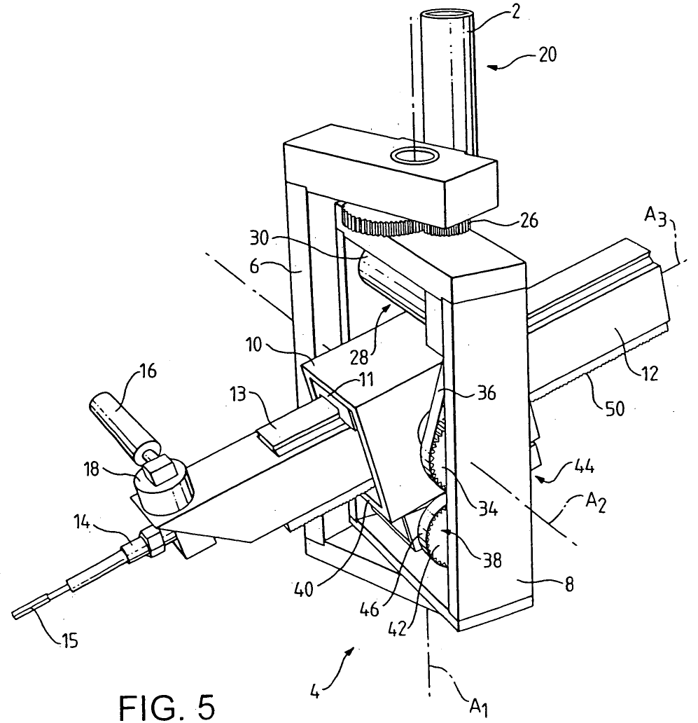

FIGS. 5 to 16 illustrate an active-constraint training robot 4 in accordance with a preferred embodiment of this aspect of the present invention.

The robot 4 is of a small, compact and lightweight design and comprises a first body member 6, in this embodiment a C-shaped member, which is fixedly mounted to the gross positioner 3, a second body member 8, in this embodiment a rectangular member, which is rotatably disposed to and within the first body member 6 about a first axis A₁, a third body member 10, in this embodiment a square tubular member, which includes a linear bearing 11 mounted to the inner, upper surface thereof and is rotatably disposed to and within the second body member 8 about a second axis A₂ substantially orthogonal to the first axis A₁, a fourth body member 12, in this embodiment an elongate rigid tubular section, which includes a rail 13 which is mounted along the upper, outer surface thereof and is a sliding fit in the linear bearing 11 on the third body member 10 such that the fourth body member 12 is slideably disposed to and within the third body member 10 along a third axis A₃ substantially orthogonal to the second axis A₂, and a cutting tool 14 which is removably disposed to the forward end of the fourth body member 12.

In this embodiment the axes of the two rotational joints, that is, the pitch and yaw, and the translational joint, that is the in/out extension, intersect in the centre of the robot 4, thus forming a spherical manipulator.

In this embodiment the cutting tool 14 includes a rotary cutter 15, for example a rotary dissecting cutter, at the distal end thereof.

In this embodiment the fourth body member 12 is hollow to allow the motor, either electric or air-driven, and the associated cabling or tubing of the cutting tool 14 to be located therewithin.

The robot 4 further comprises a grip member 16, in this embodiment a handle, which is coupled to the fourth body member 12 and gripped by a surgeon to move the cutting tool 14, and a force sensor unit 18, in this embodiment a force transducer, for sensing the direction and magnitude of the force applied to the grip member 16 by the surgeon. In use, the surgeon operates the robot 4 by applying a force to the grip member 16. The applied force is measured through the force sensor unit 18, which measured force is used by the control unit to operate the motors 22, 30, 40 to assist or resist the movement of the robot 4 by the surgeon.

The robot 4 further comprises a first back-driveable drive mechanism 20, in this embodiment comprising a servo-controlled motor 22, a first gear 24 connected to the motor 22 and a second gear 26 connected to the second body member 8 and coupled to the first gear 24, for controlling the relative movement (yaw) of the first and second body members 6, 8.

The robot 4 further comprises a second back-driveable drive mechanism 28, in this embodiment comprising a servo-controlled motor 30, a first toothed pulley 32 connected to the motor 30, a second toothed pulley 34 connected to the third body member 10 and a belt 36 coupling the first and second pulleys 32, 34, for controlling the relative movement (pitch) of the second and third body members 8, 10.

The robot 4 further comprises a third back-driveable drive mechanism 38, in this embodiment comprising a servo-controlled motor 40, a first toothed pulley 42 connected to the motor 40, a second toothed pulley 44 rotatably mounted to the third body member 10, a belt 46 coupling the first and second pulleys 42, 44, a pinion 48 connected to the second pulley 44 so as to be rotatable therewith and a rack 50 mounted along the lower, outer surface of the fourth body member 12 and coupled to the pinion 48, for controlling the relative movement (in/out extension) of the third and fourth body members 10, 12.

In this embodiment the rotational axes, that is, the pitch and yaw, of the robot 4 are in the range of about ±30°, and the range of extension is about from 20 to 35 cm. The permitted workspace of the robot 4 is constrained to a relatively small volume in order to increase the safety of the system.

In a preferred embodiment the power of the motors 22, 30, 40 is relatively small, typically with a maximum possible force of approximately 80 N at the tip of the robot 4, as a further safety measure.

In this embodiment all three of the joints between the first to fourth body members 6, 8, 10, 12 are back-driveable and have similar mechanical impedance. With this configuration, the cutting tool 14 at the tip of the robot 4 can easily be moved with a low force in any direction when the motors 22, 30, 40 are unpowered. This is a significant feature of the robot 4 as the surgeon, when guiding the robot 4, is able to feel the contact forces at the cutter 15, which would be undetectable when using a very rigid and non-back-driveable robot.

During a surgical procedure, the robot system is covered by sterile drapes to achieve the necessary sterility of the system. This system advantageously requires only the sterilisation of the cutting tool 14 and the registration tool as components which are detachably mounted to the fourth body member 12 of the robot 4. After the robot system is so draped, the registration tool and the cutting tool 14 can be pushed through the drapes and fixed in position.

The ACROBOT™ active-constraint robot system could be used to provide a variety of constraint walls, ranging from a central groove with a sense of spring resistance increasing as the user attempted to move away from the central groove, through to a variable width of permitted motion with hard walls programmed at the limits of motion. A further embodiment of the motor control system could be used to compensate for the gravitational and frictional components of the mechanism, so that the user did not feel a resistance to motion due to the restricting presence of the mechanism.

The motor system is preferably an electric motor servo system, but could also utilise fluid, hydraulic or pneumatic, power or stepper motor control.

Two separate mechanisms could also be provided, one for each hand, so that, for example, a soldering iron could be held in one hand at the end of one mechanism and a solder dispenser in the other hand at the end of the other mechanism. Such a two-handed system could be used to train a user to precisely solder a number of connections, for example, to solder an integrated circuit chip onto a printed circuit board.

Turning next to FIGS. 17 and 18, we will describe a NURBS-based method by which the active-constraint robot may be controlled.

Where flat surfaces are used, for example, with the current generation of total-knee prosthesis components, and simple, typically spherical, geometry exists for unicompartmental components, control can be based on simple geometrical primitives. In the case of a NURBS-based approach, however, no basic primitives are available, and a control methodology has to be used to restrict the movements of the surgeon to comply with the surface or surfaces as defined by the NURBS control points.

In the ACROBOT™ robot system as described above, a cutter tool is positioned at the end of a robot arm. This arm is configured to provide yaw, pitch and in/out motions for the cutter tool. Each of these motions is driven by a motor, with the motors being geared to be back-driveable, that is, moveable under manual control when the motors are unpowered. With the motors powered, the robot is capable of aiding the surgeon, for example, by power assisting the movements, compensating for gravity, or resisting the movements of the surgeon, normally at a constraint boundary to prevent too much bone from being cut away or damage to the surrounding tissue. Assistance or resistance is achieved by sensing the applied force direction and applying power to the motors in a combination which is such as to produce force either along that force vector for assistance, or backwards along that force-vector for resistance.

In a simple system, a flat plane and an outline tunnel, which is defined by a series of co-ordinates around its outline, could define the constraint region, with the proximity to the plane being computed from the plane equation, and the proximity to the tunnel being computed by searching the co-ordinate list to find the nearest matching outline segment. With this control system, as the surgeon moves the cutter tool closer to a boundary, the robot would be stiffened and the resistance increased.

FIG. 17 illustrates the general principle of such a simple proximity test, being exemplified in 2D for ease of illustration. In position 1′, the tool tip is well away from the constraint region, so the ease of movement (indicated by the lengths of the arrows) is free in all directions. In position 2′, the tool is close to the boundary, so, whereas movement away from the boundary is easy, any movement towards the boundary is made difficult by the application of a constraining force pushing back against any outward motion.

Rather than measure absolute proximity, it is proposed to provide a more effective method of determination in which, for a given force vector, the movements of the surgeon are analysed to determine whether those movements would break through the constraint boundary, and the distance to that section of the boundary is determined, rather than merely finding the closest section. This control method advantageously allows the surgeon to work freely parallel, but close to, a surface boundary. If a simple proximity test were used, working parallel and close to a surface boundary would be difficult since the close boundary proximity would be detected, resulting in resistance from the robot.

A NURBS proximity determination has the advantage of being computationally less intensive than other NURBS computations. In order to determine the closest point on a NURBS surface S from a particular point P, a Newton-Raphson iterative approach is used (Piegl, L., Tiller W., ‘The NURBS Book’—Second Edition, Springer Verlag, 1997 (ISBN 3-540-61545-8)). This iteration is set up to minimise the function S-P. The starting point for the search can theoretically be anywhere on the surface. However, faster convergence on the minimum can be achieved by first tessellating the NURBS surface coarsely into a set of quadrilaterals and then scanning the tessellated surface for the closest tessellation. The search is then started from the closest tessellation found. Once the closest point is found, the distance between this point and the tool tip is computed, and constraint forces are applied to the active-constraint robot to ensure that boundaries are not crossed.

The determination of the intersection with the NURBS surface allows for a more accurate determination as to whether a restraining force needs to be applied near a constraint boundary. This determination allows for a differentiation between heading towards or away from a surface, in which cases constraint forces are required or not required respectively, whereas a simple proximity test does not allow for such a determination and would result in the application of a constraining force in all circumstances for safety. Collision detection with a NURBS surface is, however, a difficult task. It is simpler to tessellate the surface into small regions and scan these regions to determine the intersection point. However, there comes a point where this becomes time consuming, since, for a high resolution, to determine the intersection point exactly, a large number of small tessellated triangles will be needed. The search time for such a list would be considerable.

It has been established that it is possible, providing the surface is relatively smooth, to reduce the search time by hierarchically tessellating the surface. An initial low-resolution tessellated surface with relatively large facets is first tested to determine the approximate position of the intersection. When this position is found, the position indexes a higher resolution tessellated grid around this region. This grid is localised and therefore still of relatively small in size. Trade-offs between memory and processing power may allow deeper tessellated nesting to provide a higher resolution for the intersection point.

FIG. 18 illustrates this determination graphically. The tool tip P is represented by a ball on the end of a shaft. For a complex surface, a ball-ended or acorn-type tool would be used rather than the barrel cutter used for flat plane cutting. A force vector V, indicating the direction in which the surgeon is applying force, is projected from the tool tip P through the NURBS surface S.

In a first pass, the closest large tessellation is found. This position is then linked to a finer tessellation mesh, and finally to a yet finer tessellation mesh. In this particular example, the intersection point I is found after a search through, at maximum, 48 facets. In an ordinary search without hierarchy, up to 4096 facets would have had to have been searched to find the intersection point I to the same resolution. It will be understood that this example is fairly simplistic in order to allow for easy exemplification of the concept. In reality, the sizes of the facets, and the number at each level will be governed by the complexity of the surface. A very simple smooth surface needs to contain few facets at any level of detail, whereas a more complex or bumpy surface will require more facets to provide an approximation of the bumps at the top level.

Once the intersection point I is found, the distance from the tool tip P is computed simply, and the force applied by the surgeon measured. The constraining force required is then a function of the distance and the force.

Finally, it will be understood that the present invention has been described in its preferred embodiments and can be modified in many different ways without departing from the scope of the invention as defined by the appended claims.

1. A training system for training a user in the operation of a tool, comprising:
a movable tool (3000);
a grip member (2000) coupled to the tool and gripped in use by a user to move the tool;
a drive unit for constraining the movement of the tool in a definable virtual region of constraint; and
a control unit for controlling the drive unit so as to constrain the movement of the tool in successively increasingly-broader virtual regions of constraint, as the user's physical skill increases.

2. A training system as claimed in claim 1 in which the regions of constraint define successively broader paths within which the tool (3000) is permitted to move.

3. A training system as claimed in claim 2 in which the paths are two-dimensional.

4. A training system as claimed in claim 2 in which the paths are three-dimensional.

5. A training system as claimed in any one of claims 2 to 4 in which the successively-broader paths further define successively-deeper grooves.

6. A training system as claimed in any one of the preceding claims in which the virtual regions of constraint are defined by hard virtual walls.

7. A training system as claimed in any one of claims 2 to 5 in which the user feels a sense of spring-resistance as the tool (3000) is moved away from a central groove of the paths.

8. A training system as claimed in claim 7 in which the grip-member is a joystick.

9. A training system as claimed in any one of the preceding claims in which the control unit compensates for gravity and friction within the training system, so that the user does not feel a resistance to motion of the tool due to the presence of the training system.

10. A training system as claimed in any one of the preceding claims including a computer display for providing visualization of the actual tool location and path, as well as the user's desired tool path.

11. A training system as claimed in any one of the preceding claims including two movable tools and corresponding grip members, one for each of the user's hands.

12. A method of training a user in the operation of a tool comprising:
providing a training system including a movable tool (3000), a grip member (2000) coupled to the tool and gripped by a user to move the tool, and a drive unit for constraining the movement of the tool;
operating the drive unit to constrain movement of the tool in a virtual region of constraint; and
as the user's physical skill increases, operating the drive unit to constrain movement of the tool in successively-broader virtual regions of constraint.

13. A method as claimed in claim 12 in which the regions of constraint define successively broader paths within which the tool (3000) is permitted to move.

14. A method as claimed in claim 13 in which the paths are two-dimensional.

15. A method as claimed in claim 13 in which the paths are three-dimensional.

16. A method as claimed in claims 13 to 15 in which the successively-broader paths further define successively-deeper grooves.

17. A method as claimed in claims 12 to 16 in which the virtual regions of constraint are defined by hard virtual walls.

18. A method as claimed in claims 13 to 16 in which the grip-member is a spring-centred joystick.

19. A method as claimed in claims 12 to 18 including operating the drive unit to compensate for gravity and friction within the training system, so that the user does not feel a resistance to motion of the tool due to the presence of the training system.

20. A method as claimed in claims 12 to 19 including providing visualization of the actual tool location and path, as well as the user's desired tool path.
